(19) United States
(12) Patent Application Publication
(10) Pub. No.: US 2025/0384585 A1
(43) Pub. Date: Dec. 18, 2025

(54) INFORMATION PROCESSING DEVICE, INFORMATION PROCESSING METHOD, AND NON-TRANSITORY COMPUTER READABLE RECORDING MEDIUM

(71) Applicant: PANASONIC INTELLECTUAL PROPERTY MANAGEMENT CO., LTD, Osaka (JP)

(72) Inventor: Nobuhiko WAKAI, Tokyo (JP)

(21) Appl. No.: 19/316,597

(22) Filed: Sep. 2, 2025

Related U.S. Application Data
(63) Continuation of application No. PCT/JP2023/040275, filed on Nov. 8, 2023.

(30) Foreign Application Priority Data
Mar. 23, 2023 (JP) 2023-047263

(51) Int. Cl. G06T 7/80; G06T 7/68

(52) U.S. Cl. CPC G06T 7/80; G06T 7/68; G06T 2207/20081; G06T 2207/30244

(57) ABSTRACT

An information processing apparatus acquires an image taken by a camera and estimates a vanishing point and auxiliary diagonal points from the image, and the auxiliary diagonal points projected on a unit sphere in a world coordinate system include one point of a set of eight or more points arranged to maintain symmetry of a regular octahedron inscribed in the unit sphere.

### FIELD OF INVENTION

The present disclosure relates to a technique of detecting a posture of a camera.

### BACKGROUND ART

Recently, there has been known a technique of estimating a plurality of vanishing points from an image having a distortion on the basis of Manhattan World Assumption (e.g., Non-Patent Literature 1 and 2). This technique involves: acquiring an image having a distortion; detecting a plurality of arcs from the acquired image as candidates for a height direction, a front-rear direction, and a lateral direction on the basis of Manhattan World Assumption; searching for an optimum combination from the detected arcs; and estimating a plurality of vanishing points from a result of the search.

In the conventional technique above, however, only the vanishing points are detected. Therefore, a posture of a camera cannot be uniquely determined in a case where a vanishing point necessary to uniquely determine the posture of the camera cannot be detected.
Non-Patent Literature 1: Y. Lochman, O. Dobosevych, R. Hryniv, and J. Pritts. Minimal solvers for single-view lens-distorted camera autocalibration. In Proceedings of IEEE Winter Conference on Applications of Computer Vision (WACV), pages 2886-2895, 2021.
Non-Patent Literature 2: J. Pritts, Z. Kukelova, V. Larsson, and O. Chum. Radially-distorted conjugate translations. In Proceedings of IEEE/CVF Conference on Computer Vision and Pattern Recognition (CVPR), pages 1993-2001, 2018.

### SUMMARY OF THE INVENTION

An object of the present disclosure is to provide a technique that enables provision of information necessary to uniquely determine a posture of a camera even in a case where a vanishing point necessary to uniquely determine the posture of the camera cannot be detected.

An information processing apparatus according to one aspect of the present disclosure includes: an acquisition part for acquiring an image taken by a camera; and an estimation part for estimating a vanishing point and auxiliary diagonal points from the image, and the auxiliary diagonal points projected on a unit sphere in a world coordinate system include one point of a set of eight or more points arranged to maintain symmetry of a regular octahedron inscribed in the unit sphere.

This configuration enables provision of information necessary to uniquely determine a posture of a camera even in a case where a vanishing point necessary to uniquely determine the posture of the camera cannot be detected.

### BRIEF DESCRIPTION OF THE DRAWINGS

FIG. 1 is a diagram showing an exemplary configuration of an information processing apparatus according to a first embodiment of the present disclosure.

FIG. 2 is a flowchart of an exemplary process in the first embodiment.

FIG. 3 is an illustration showing exemplary world coordinate system and camera coordinate system.

FIG. 4A is a flowchart showing an exemplary process in a modification 1 of the first embodiment.

FIG. 4B is a flowchart showing an exemplary process in a modification 2 of the first embodiment.

FIG. 5 is a diagram showing an exemplary configuration of an information processing apparatus according to a second embodiment.

FIG. 6 is a flowchart showing an exemplary process of the information processing apparatus according to the second embodiment.

FIG. 7 is a diagram showing an outline of the process in the second embodiment.

FIG. 8 is a diagram showing an exemplary configuration of an information processing apparatus according to a third embodiment.

FIG. 9 is a flowchart showing an exemplary process of the information processing apparatus according to the third embodiment.

FIG. 10 is an illustration showing vanishing points and auxiliary diagonal points in a first pattern, which are projected on a unit sphere.

FIG. 11 is a table showing arrangement of the vanishing points and the auxiliary diagonal points shown in FIG. 10.

FIG. 12 is a diagram showing an exemplary configuration of an information processing apparatus according to a fourth embodiment.

FIG. 13 is a flowchart showing an exemplary process of the information processing apparatus according to the fourth embodiment.

FIG. 14 is an illustration showing auxiliary diagonal points in a second pattern.

FIG. 15 is an illustration showing auxiliary diagonal points in a third pattern.

### DETAILED DESCRIPTION

### Circumstances That Led to One Aspect of Present Disclosure

In automatic drive control of a mover such as an automobile and a drone, a posture of the mover is regarded as a rotation with respect to a road. Therefore, the mover is provided with an odometry or gyro sensor for estimation of the posture. Typically, the mover is provided with a camera for external sensing. An ability to estimate the posture of the mover by only the camera eliminates necessity of the odometry or gyro sensor, which is preferable.

A unique determination of the posture of the camera requires detection of vanishing points for at least two axes. The detection of the vanishing points for at least two axes means that at least one vanishing point corresponding to each of the at least two axes among three axes defining a world coordinate system is detected.

However, there are many cases where one or less vanishing point is detected from an image. In such cases, the posture of the camera cannot be uniquely determined.

Non-Patent Literature 1 and 2 above involves detecting a plurality of arcs from an image as candidates for a height direction, a front-rear direction, and a lateral direction on the basis of Manhattan World Assumption; and estimating a plurality of vanishing points based on the detected arcs. However, in Non-Patent Literature 1 and 2, only the vanishing points are detected; therefore, in a case where the number of the detected vanishing points is insufficient, the posture of the camera cannot be uniquely determined. Further, Non-Patent Literature 1 and 2 is intended for a view of buildings systematically arranged along a road. Therefore, in Non-Patent Literature 1 and 2, an arc cannot be accurately detected for an urban area having trees arranged along a road, which blur contours of a building. Thus, a vanishing point cannot be estimated accurately, and therefore the posture of the camera cannot be accurately determined.

In this regard, the present inventor has considered defining a new point distinct from the vanishing point in order to uniquely determine the posture of the camera. A local distribution of the distinct points increases probability that information on a point corresponding to one axis only is obtained from an image. Therefore, it is desirable for the distinct points to be distributed in a space as uniformly as possible. Further, the distinct points must have a strong geometric constraint like a vanishing point; otherwise, the points become difficult to detect from an image.

There are two vanishing points for each of the three axes in the world coordinate system, resulting in six vanishing points in total. The six vanishing points projected on a unit sphere in the world coordinate system are at vertices of a regular octahedron. To achieve a spatially uniform distribution of a minimized number of the distinct points, it is desirable for the distinct points to be arranged to maintain symmetry of the regular octahedron. The six vertices of the regular octahedron forms eight-direction symmetry referred to as a regular octahedron group (8G). Therefore, as described later, eight or more points, e.g., 8, 12, or 24, can be added to maintain the symmetry of the regular octahedron.

The present inventor has found that: points arranged to maintain the symmetry of the regular octahedron can be defined as auxiliary diagonal points, which are arranged spatially uniformly without a large number of the points being arranged and have a strong geometric constraint; and this enables provision of information necessary to uniquely determine the posture of the camera even if a sufficient number of vanishing points are not obtained, thus conceiving the present disclosure.

(1) An information processing apparatus according to one aspect of the present disclosure includes: an acquisition part for acquiring an image taken by a camera; and an estimation part for estimating a vanishing point and auxiliary diagonal points from the image, and the auxiliary diagonal points projected on a unit sphere in a world coordinate system include one point of a set of eight or more points arranged to maintain symmetry of a regular octahedron inscribed in the unit sphere.

In this configuration, the auxiliary diagonal points are estimated in addition to the vanishing point. The auxiliary diagonal points include one point of a set of the eight or more points that can maintain the symmetry of the six vanishing points corresponding to the vertices of the regular octahedron projected onto the unit sphere. Thus, the projected auxiliary diagonal points are arranged spatially uniformly and have the strong geometric constraint similar to the vanishing point. This configuration can provide information that enables unique determination of the posture of the camera regardless of lack of a vanishing point estimated from an image.

(2) In the information processing apparatus described in (1) above, the auxiliary diagonal points may include at least one of eight vertices of a cube inscribed in the unit sphere.

It has been found that a group of eight points of a cube inscribed in the unit sphere ensures the greatest uniformity among point groups each consisting of eight points to maintain the symmetry of the regular octahedron group. In this configuration, the eight vertices of the cube inscribed in the regular octahedron serve as the auxiliary diagonal points. Thus, points ensuring great uniformity can be defined as the auxiliary diagonal points.

(3) In the information processing apparatus described in (1) or (2) above, the estimation part may include a vanishing point estimation part for estimating the vanishing point and the auxiliary diagonal points by inputting the image to a first learning model and an intrinsic parameter estimation part for estimating an intrinsic parameter of the camera by inputting the image to a second learning model; the first learning model may be trained by machine learning in advance for estimating the vanishing point and the auxiliary diagonal points, and the second learning model may be trained by machine learning in advance for estimating the intrinsic parameter.

This configuration enables estimation of a vanishing point and auxiliary diagonal points, and an intrinsic parameter from an image acquired by the acquisition part. Further, the vanishing points and the intrinsic parameter are estimated by respective learning models. Therefore, the vanishing points and the intrinsic parameter can be estimated accurately.

(4) In the information processing apparatus described in (3) above, the first learning model may generate heatmaps indicative of a likelihood of vanishing point and a likelihood of auxiliary diagonal point at each of a plurality of pixels from the input image, and the vanishing point estimation part may estimate the vanishing point and the auxiliary diagonal points on the basis of the heatmaps.

In this configuration, vanishing points are estimated from the heatmaps. Thus, the accuracy in the estimation of the vanishing points can be improved.

(5) The information processing apparatus described in any one of (1) to (4) above may further include: a projection part for projecting the estimated vanishing point and auxiliary diagonal points onto the unit sphere on the basis of an intrinsic parameter of the camera; and a calculation part for calculating a rotation angle indicative of a posture of the camera on the basis of errors between the vanishing point and the auxiliary diagonal points projected by the projection part, and a reference vanishing point and reference auxiliary diagonal points projected onto the unit sphere in advance.

In this configuration, the rotation angle is calculated on the basis of the error between the vanishing point projected by the projection part and the reference vanishing point projected onto the unit sphere in advance, and the errors between the auxiliary diagonal points projected by the projection part and the reference auxiliary diagonal points projected onto the unit sphere in advance. Thus, the rotation angle indicative of the posture of the camera can be calculated accurately.

(6) An information processing method according to another aspect of the present disclosure, by a computer, includes: acquiring an image taken by a camera; and estimating a vanishing point and auxiliary diagonal points from the image, and the auxiliary diagonal points projected on a unit sphere in a world coordinate system include one point of a set of eight or more points arranged to maintain symmetry of a regular octahedron inscribed in the unit sphere.

This configuration enables provision of an information processing method that can provide information necessary to uniquely determine the posture of the camera even in a case where a vanishing point necessary to uniquely determine the posture of the camera cannot be detected.

(7) An information processing program according to still another aspect of the present disclosure causes a computer to serve as the information processing apparatus described in any one of (1) to (5) above.

This configuration enables provision of an information processing program that can provide information necessary to uniquely determine the posture of the camera even in a case where a vanishing point necessary to uniquely determine the posture of the camera cannot be detected.

The disclosure can be realized as an information processing system operated by the information processing program. Additionally, it goes without saying that the program is distributable as a non-transitory computer readable storage medium like a CD-ROM, or distributable via a communication network like the Internet.

Each of the embodiments which will be described below represents a specific example of the disclosure. Numerical values, shapes, constituents, steps, and the order thereof described below are mere examples, and thus should not be construed to delimit the disclosure. Further, constituents which are not recited in the independent claims each showing the broadest concept among the constituents in the embodiments are described as selectable constituent. The respective contents are combinable with each other in all the embodiments.

### First Embodiment

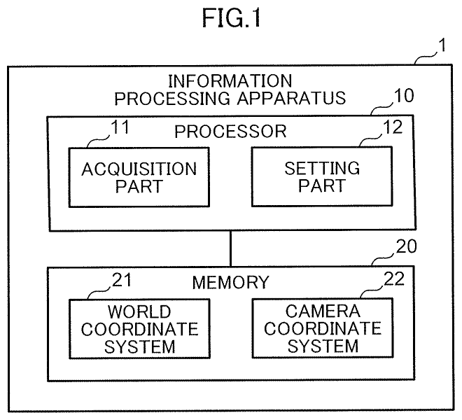

FIG. 1 is a diagram showing an exemplary configuration of an information processing apparatus 1 according to a first embodiment of the present disclosure. The information processing apparatus 1 is included in a computer having a communication interface. The information processing apparatus 1 is included in a cloud server, or may be included in an edge computer. The information processing apparatus 1 includes a processor 10 and a memory 20. The processor 10 includes, e.g., a central processing unit (CPU). The processor 10 includes an acquisition part 11 and a setting part 12. The acquisition part 11 and the setting part 12 do performance when the processor 10 executes an information processing program. The acquisition part 11 and the setting part 12 are included in one computer, or may be distributed to a plurality of computers. The processor 10 and the memory 20 are included in one computer, or may be distributed to a plurality of computers.

The acquisition part 11 acquires information indicative of coordinate axes of a world coordinate system 21 from the memory 20. The world coordinate system 21 is a three- dimensional coordinate system based on Manhattan World Assumption. The acquisition part 11 acquires information indicative of coordinate axes of a camera coordinate system 22 from the memory 20 to thereby acquire a front direction of a camera 2. The camera coordinate system 22 is a coordinate system of a camera mounted on a mover. The front direction of the camera is predetermined in the camera coordinate system 22. In the embodiment, the front direction of the camera 2 is regarded as representing a front direction of the mover 3. The mover is not narrowly limited to an automobile; the mover may be a device that a person wears, e.g., smart glasses (eyeglass-type electronic display device).

The setting part 12 sets a first axis being one axis of two axes defining ground as a reference axis for a pan angle of the camera 2 in the world coordinate system 21. The first axis includes a first direction pointing from an origin of the world coordinate system 21 to one side and a second direction pointing from the origin to the other side. In the present disclosure, the ground refers to a reference surface to constitute an image obtained by the camera, and includes indoor and outdoor floor surfaces as well as a road.

The setting part 12 calculates a first angle between the first direction and the front direction of the camera 2 and a second angle between the second direction and the front direction of the camera 2. The setting part 12 sets a direction of the first axis pointing to a side having the smaller angle of the first angle and the second angle to the forward direction.

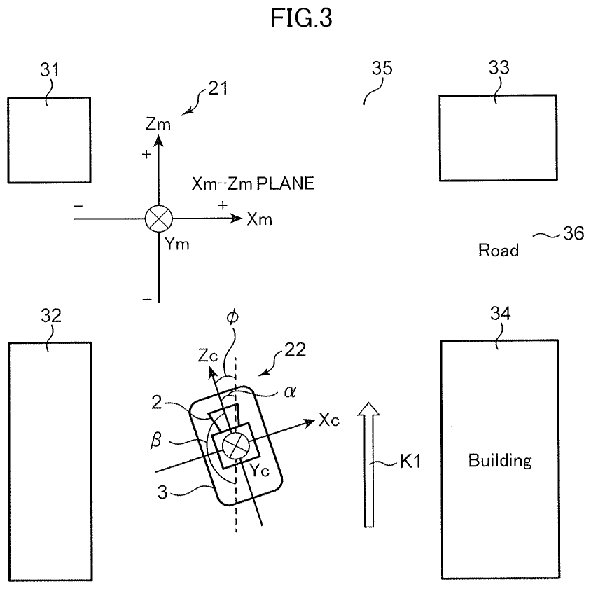

FIG. 3 is an illustration showing exemplary world coordinate system 21 and camera coordinate system 22. The world coordinate system 21 in FIG. 3 has three coordinate axes Xm, Ym, Zm orthogonal to each other. The world coordinate system 21 is right-handed. The world coordinate system 21 is a coordinate system based on Manhattan World Assumption. In Manhattan World Assumption, the world is regarded as being composed of grid-shaped roads 35, 36. Two axes of the three axes of the world coordinate system 21 are parallel to the roads 35, 36, and the remaining one axis defines a height direction orthogonal to the ground. In the example in FIG. 3, the Xm-axis is parallel to the road 36, the Zm-axis is parallel to the road 35, and the Ym-axis defines the height direction. In Manhattan World Assumption, each of buildings 31 to 34 is regarded as consisting of a cuboid. A downward direction of the Ym-axis represents a positive direction thereof.

In the embodiment, an Xm-Zm plane represents a surface defining the ground, which is supposed to be already known.

The camera coordinate system 22 is a coordinate system for the camera 2 mounted on the mover 3. The camera coordinate system 22 is a three-dimensional coordinate system having three axes orthogonal to each other, which are an Xc-axis, a Yc-axis, and a Zc-axis. The camera coordinate system 22 is right-handed. The Zc-axis defines the front direction of the camera 2. Since the front direction of the camera 2 corresponds to the front direction of the mover 3, the Zc-axis defines the front direction of the mover 3. For a brief explanation, the roll angle and the tilt angle are assumed to be zero degrees in the description below, but are not limited to zero degrees in the present invention; the present invention can be carried out at arbitrary roll angle and tilt angle. For example, in a case where the roll angle is 180 degrees and the tilt angle is zero degrees, a downward direction of a Yc-axis described later represents a negative direction (a 180 degree rotation for the roll angle causes the camera coordinate system to be vertically inverted). The Yc-axis defines the height direction orthogonal to the ground. The Xc-axis defines lateral directions of the camera 2 and the mover 3. An Xc-Zc plane is parallel to the Xm-Zm plane. In the embodiment, the arrangement of the camera coordinate system 22 in the world coordinate system 21 is supposed to be already known. A downward direction of the Yc-axis represents a positive direction thereof.

For calculation of a pan angle φ of the camera 2, it is desirable to set either of the Zm-axis or the Xm-axis as a reference axis for the pan angle φ. Further, for definition of the pan angle q, it is desirable to define which direction of the reference axis represents forward and which direction represents rearward. Additionally, it is desirable to define directions orthogonal to the forward and the rearward directions on the ground as lateral directions, and define which direction of the lateral directions represents a rightward direction and which direction thereof represents a leftward direction.

In the conventional techniques, no particular process for setting the reference axis for the pan angle φ has been executed; a reference axis for the pan angle φ is randomly selected from the Zm-axis and the Xm-axis every time the pan angle is calculated. Thus, the conventional techniques involve the four-fold rotational symmetric ambiguity, which limits the pan angle to within a range from −45 degrees to 45 degrees.

Accordingly, in the embodiment, the setting part 12 sets the first axis being one axis of the Xm-axis and the Zm-axis defining the ground as the reference axis for the pan angle of the camera 2 in the world coordinate system 21. Here, the Zm-axis parallel to a predetermined road direction K1 is set as the reference axis. This setting eliminates the four-fold rotational symmetric ambiguity.

The setting part 12 calculates a first angle a between a positive direction (first direction) of the Zm-axis and the Zc-axis. The setting part 12 calculates a second angle β between a negative direction (second direction) of the Zm-axis and the Zc-axis. The setting part 12 sets a forward direction that lies on a direction of the Zm-axis and points to a side having the smaller angle of the first angle α and the second angle β. Since the first angle α is smaller than the second angle β in the example, the positive direction of the Zm-axis is set as the forward direction. The setting part 12 sets the positive direction of the Xm-axis that is rightward with respect to the front represented by the forward direction as a rightward direction, and the negative direction of the Xm-axis that is leftward as a leftward direction. The four directions, frontward, rearward, rightward, and leftward directions, are defined.

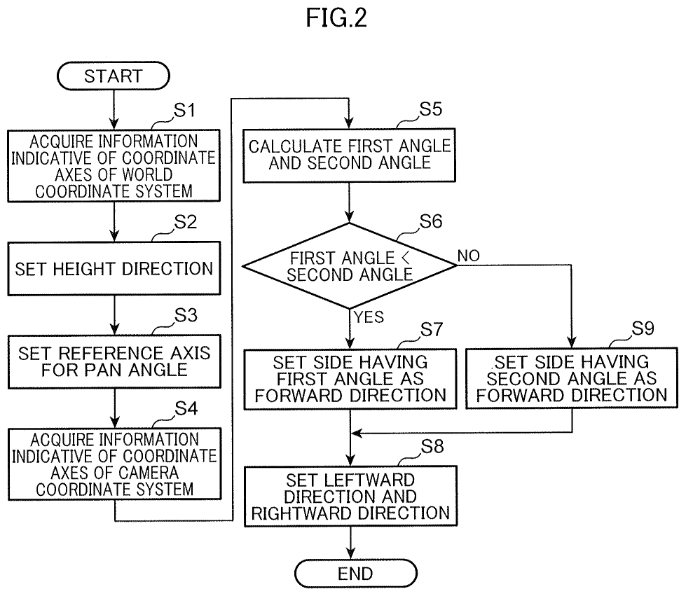

FIG. 2 is a flowchart of an exemplary process in the first embodiment. First, in Step S1, the acquisition part 11 acquires information indicative of the coordinate axes of the world coordinate system 21 from the memory 20. Next, in Step S2, among the three axes of the world coordinate system 21, the Ym-axis that is orthogonal to the Xm-Zm plane corresponding to the ground is set as the height direction. Next, in Step S3, the setting part 12 sets the Zm-axis parallel to the road direction K1 as the reference axis for the pan angle φ. Next, in Step S4, the acquisition part 11 acquires information indicative of the coordinate axes of the camera coordinate system 22 from the memory 20.

Next, in Step S5, the setting part 12 calculates the first angle a and the second angle β shown in FIG. 3. Next, in Step S6, the setting part 12 determines whether the first angle α is smaller than the second angle β. In a case where the first angle α is smaller than the second angle β (YES in Step S6), the setting part 12 sets a side having the first angle α on the Zm-axis as the forward direction (Step S7). In the example in FIG. 3, the positive direction of the Zm-axis is set as the forward direction. On the other hand, in a case where the first angle α is not smaller than the second angle β (NO in Step S6), the setting part 12 sets a side having the second angle β on the Zm-axis as the forward direction (Step S9). In the example in FIG. 3, the negative direction of the Zm-axis is set as a rearward direction. Next, in Step S8, the setting part 12 sets a leftward direction and a rightward direction on the Xm-axis. In the example in FIG. 3, the positive direction of the Xm-axis is set as the rightward direction, and the negative direction of the Xm-axis is set as the leftward direction.

As described above, in the embodiment, the Zm-axis among the Xm-axis and the Zm-axis defining the ground in the three-dimensional world coordinate system 21 based on Manhattan World Assumption is set as the reference axis for the pan angle φ of the camera 2. Thus, the pan angle φ can be expressed with respect to the Zm-axis for estimation of the pan angle from an image, and a particular direction in which the camera 2 faces can be precisely expressed. Accordingly, the pan angle can be precisely expressed even in a place having the four-fold rotational symmetric ambiguity such as a crossroads. The ability to precisely express the pan angle enables accurate determination of a specific direction from which an image has been taken by the camera.

### Modification 1 of First Embodiment

In a case where the forward direction is set as the reference direction but a traveling direction of the mover 3 agrees with the rearward direction, the pan angle is expressed beyond the range from −90 degrees to 90 degrees, which is hard to handle. The modification 1 of the first embodiment involves setting the rearward direction as the reference direction for the pan angle in such a case.

Hereinafter, the modification of the first embodiment will be described with reference to FIG. 1. The setting part 12 sets, when acquiring first direction information indicating that an image taken by the camera 2 represents a rear side with respect to the forward direction being set as the reference direction for the pan angle, the rearward direction opposite to the forward direction as the reference direction for the pan angle.

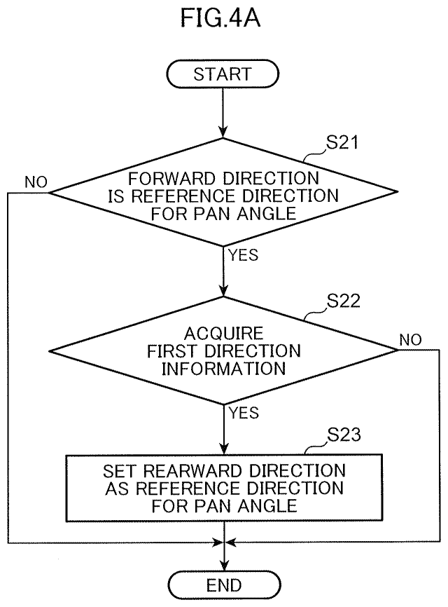

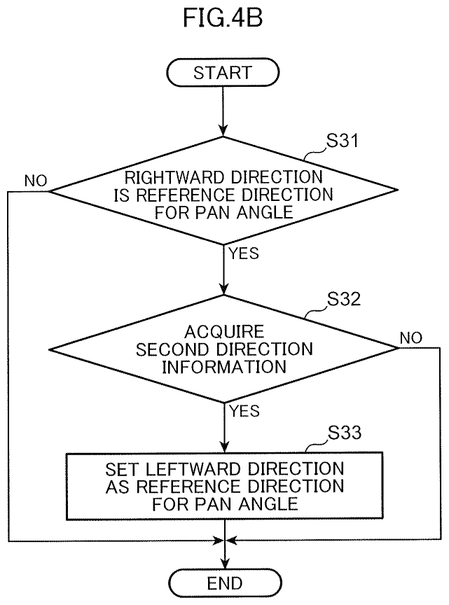

FIG. 4A is a flowchart showing an exemplary process in the modification 1 of the first embodiment. The flowchart shown in FIG. 4A is executed when, for example, the camera 2 takes an image while the mover 3 travels on the road. The forward, rearward, rightward, and leftward directions are already assigned to the Xm-axis and the Zm-axis according to the flowchart shown in FIG. 2, before the execution of the flowchart shown in FIG. 4A.

First, in Step S21, the setting part 12 determines whether the forward direction is set as the reference direction for the pan angle. In a case where the forward direction is not set as the reference direction for the pan angle (NO in Step S21), the process ends. On the other hand, in a case where the forward direction is set as the reference direction for the pan angle (YES in Step S21), the setting part 12 determines whether the first direction information is acquired (Step S22). The first direction information is set in the camera 2 when, for example, an image is taken, and annexed to the image. The first direction information may be input by a user through the camera 2. In a case where the first direction information is acquired (YES in Step S22), the process proceeds to Step S23; in a case where the first direction information is not acquired (NO in Step S22), the process ends. In this case, the forward direction is kept to be the reference direction for the pan angle. Next, in Step S23, the setting part 12 sets the rearward direction as the reference direction for the pan angle.

As described above, in the modification 1 of the first embodiment, the rearward direction is set as the reference direction for the pan angle according to whether the direction information is acquired; therefore, the pan angle can be expressed in the range from −90 degrees to 90 degrees. Thus, the pan angle becomes easier to handle. In the modification 1 of the first embodiment, in a case where direction information indicating that an image taken by the camera 2 represents the forward direction is acquired after the rearward direction is set as the reference direction for the pan angle, the setting part 12 resets the forward direction as the reference direction for the pan angle.

### Modification 2 of First Embodiment

In a case where the rightward direction or the leftward direction is set as the reference direction but the traveling direction of the mover 3 agrees with an opposite direction to the reference direction, the pan angle cannot be expressed in the range from −90 degrees to 90 degrees, which is hard to handle. The modification 2 of the first embodiment involves setting the opposite direction as the reference direction for the pan angle in such a case.

The setting part 12 sets, when acquiring second direction information indicating that an image taken by the camera 2 represents an opposite direction to one of the rightward direction and the leftward direction being set as the reference direction for the pan angle, the opposite direction as the reference direction for the pan angle.

FIG. 4B is a flowchart showing an exemplary process in the modification 2 of the first embodiment. The flowchart shown in FIG. 4B is executed when, for example, the camera 2 takes an image while the mover 3 travels on the road. The forward, rearward, rightward, and leftward directions are already assigned to the Xm-axis and the Zm-axis according to the flowchart shown in FIG. 2, before the execution of the flowchart shown in FIG. 4B. This flowchart presupposes that the rightward direction is set as the reference direction by default.

First, in Step S31, the setting part 12 determines whether the rightward direction is set as the reference direction for the pan angle. In a case where the rightward direction is not set as the reference direction for the pan angle (NO in Step S31), the process ends. On the other hand, in a case where the rightward direction is set as the reference direction for the pan angle (YES in Step S31), the setting part 12 determines whether the second direction information is acquired (Step S32). In this example, it is determined whether the second information indicating that the image taken by the camera 2 represents the leftward direction is acquired. In a case where the second direction information is acquired (YES in Step S32), the process proceeds to Step S33; in a case where the second direction information is not acquired (NO in Step S32), the process ends. In this case, the rightward direction is kept to be the reference direction for the pan angle. Next, in Step S33, the setting part 12 sets the leftward direction as the reference direction for the pan angle.

As described above, in the modification 2 of the first embodiment, a direction opposite to a default reference direction is set as the reference direction for the pan angle according to whether the direction information is acquired; therefore, the pan angle can be expressed in the range from −90 degrees to 90 degrees. Thus, the pan angle becomes easier to handle. In the modification 2 of the first embodiment, in a case where direction information indicating that an image taken by the camera 2 represents the rightward direction is acquired after the leftward direction is set as the reference direction for the pan angle, the setting part 12 resets the rightward direction as the reference direction for the pan angle.

### Modification 3 of First Embodiment

In the first embodiment, the world coordinate system 21 and the camera coordinate system are right-handed, but may be left-handed.

### Second Embodiment

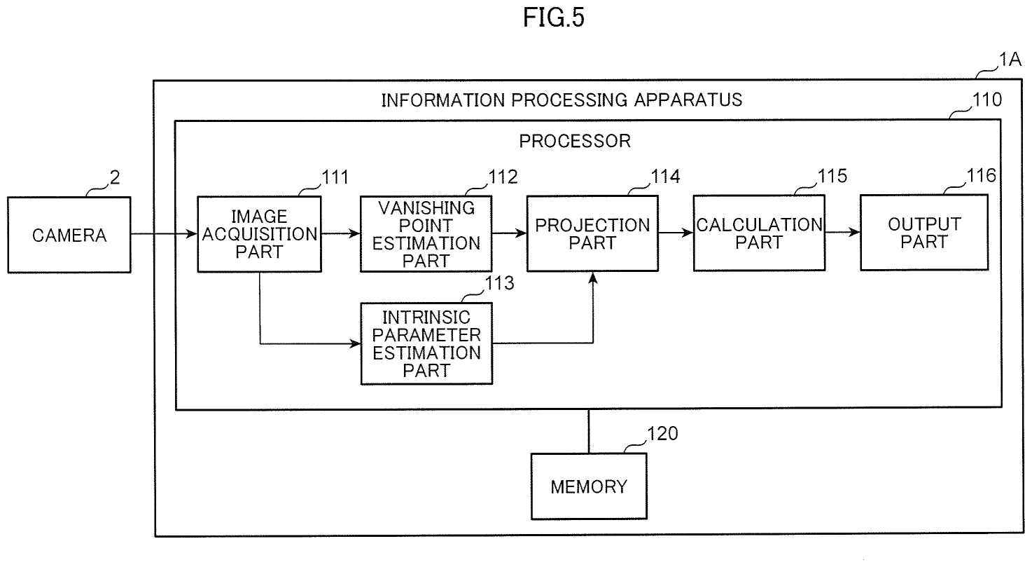

The second embodiment involves calculating a rotation angle indicative of a posture of the camera 2 using an image taken by the camera 2. FIG. 5 is a diagram showing an exemplary configuration of an information processing apparatus 1A according to the second embodiment. The second embodiment presupposes that the process described in the first embodiment has been executed to set the directions of the coordinate axes of the world coordinate system 21. A processor 110 and a memory 120 of the information processing apparatus 1A described in the second embodiment may have respective blocks that the processor 10 and the memory 20 of the information processing apparatus 1 described in the first embodiment have. These apply to third and fourth embodiments described later. In the second embodiment, the same constituents as those in the first embodiment are denoted by the same reference numerals, and the description thereof will be omitted.

The information processing apparatus 1A includes the processor 110 and the memory 120. The information processing apparatus 1A has the same hardware configuration as that of the information processing apparatus 1 shown in FIG. 1, and therefore the description thereof will be omitted. The information processing apparatus 1A and the camera 2 are connected with each other. The camera 2 is communicably connected with the information processing apparatus 1A via a certain communication channel. In a case where the information processing apparatus 1A is included in the cloud server, the communication channel is, e.g., the Internet. In a case where the information processing apparatus 1A is included in an edge device, the communication channel is, e.g., a wireless LAN or a wired LAN. In a case where the information processing apparatus 1A is installed in the mover 3, the communication channel is, e.g., an onboard network.

The camera 2 is mounted on the mover 3. For example, the camera 2 takes an image of surroundings of the mover 3 at a predetermined frame rate, and transmits the taken image to the information processing apparatus 1A at the predetermined frame rate. This is merely an example; the camera 2 may take an image of surroundings of the mover 3 in response to an imaging instruction by a user or the information processing apparatus 1A, and transmits the taken image to the information processing apparatus 1A. An example of the image is a fisheye image. Another example of the image is a panoramic image or an ordinary rectangular image. The image may be a still image.

The processor 110 includes an image acquisition part 111 (an exemplary acquisition part), a vanishing point estimation part 112 (an exemplary estimation part), an intrinsic parameter estimation part 113 (an exemplary estimation part), a projection part 114, a calculation part 115, and an output part 116. The image acquisition part 111, the vanishing point estimation part 112, the intrinsic parameter estimation part 113, the projection part 114, the calculation part 115, and the output part 116 are included in one computer, or may be distributed to a plurality of computers.

The image acquisition part 111 acquires an image from the camera 2. The vanishing point estimation part 112 estimates a plurality of vanishing points by inputting the image acquired by the image acquisition part 111 to a first learning model. The first learning model is trained by machine learning in advance for estimating the vanishing points from an image. The first learning model outputs a heatmap representing a likelihood of vanishing point at each of a plurality of pixels from the input image. The vanishing point estimation part 112 outputs the same number of sequenced heatmaps as that of predetermined vanishing points to be estimated, and associates the sequence with labels indicative of types of the vanishing points, e.g., associates a vanishing point estimated on a first heatmap and a vanishing point estimated on a second heatmap in this sequence with a rightward vanishing point and a leftward vanishing point, respectively, so that the labels indicative of types of the vanishing points can be acquired.

The coordinate of the vanishing point of each heatmap is represented by a coordinate value of a pixel indicative of a maximum likelihood. The vanishing point may not be a pixel indicative of the maximum likelihood, and may be a pixel that indicates a maximum likelihood after an application of a Gaussian filter to the heatmap. For example, in a case where a center pixel of nine specific pixels of 3 by 3 indicates a likelihood of zero and each of the other eight pixels indicates a maximum likelihood of 0.9, the center pixel that does not indicate the maximum likelihood may be estimated as a pixel representing a vanishing point. This configuration reduces an effect caused by an error in the heatmap, and thus accuracy in estimation of a vanishing point is improved. Alternatively, a vanishing point may be a pixel obtained from estimation of the vicinity of the one indicative of the maximum likelihood with subpixel accuracy.

The first learning model is generated by executing machine learning using a heatmap indicative of a true value for the vanishing point as training data. The vanishing point estimation part 112 estimates the vanishing points on the basis of the heatmaps output by the first learning model.

In the embodiment, there are six vanishing points, first to sixth vanishing points. The first vanishing point is a vanishing point in the front direction of the camera 2. The second vanishing point is a vanishing point in a direction opposite to the front direction of the camera 2. The third vanishing point is a vanishing point in a zenithal direction of the camera 2. The fourth vanishing point is a vanishing point in a direction opposite to the zenithal direction of the camera 2. The fifth vanishing point is a vanishing point in the rightward direction of the camera 2. The sixth vanishing point is a vanishing point in the leftward direction of the camera 2.

The intrinsic parameter estimation part 113 estimates an intrinsic parameter of the camera 2 by inputting the image to a second learning model. The second learning model is trained by machine learning in advance for estimating the intrinsic parameter. The intrinsic parameter includes a focal length of the camera 2 and a distortion coefficient of the camera 2. Document D1 below discloses an exemplary technique of estimating a focal length and a distortion coefficient from an image.
Document D1: N. Wakai, Y. Ishii, S. Sato, and T. Yamashita. Rethinking generic camera models for deep single image camera calibration to recover rotation and fisheye distortion. In proceedings of European Conference on Computer Vision (ECCV), volume 13678, pages 679-698, 2022.

Thus, the intrinsic parameter estimation part 113 can estimate the intrinsic parameter using the technique in Document D1.

The projection part 114 projects the vanishing points estimated by the vanishing point estimation part 112 onto a unit sphere in the world coordinate system 21 on the basis of the intrinsic parameter estimated by the intrinsic parameter estimation part 113.

For the description below, a three-dimensional rotation for the camera calibration will be described. In Document D1, an extrinsic parameter is represented by a rotation matrix. Three-dimensional coordinate values resulting from a rotational movement of three-dimensional coordinate values by use of the rotation matrix are uniquely determined; in this regard, there is a plurality of representations of the rotational movement as well as the rotation matrix. Each of the pan angle, the tilt angle, and the roll angle is an exemplary rotational representation, and can be obtained by decomposing the rotation matrix into three rotational components. The rotation matrix is decomposed under a constraint condition, for the rotation matrix cannot be decomposed uniquely. For example, a set of pan, tilt, and roll angles to minimize a sum of respective absolute values of the pan, tilt, and roll angles may be selected. The rotation matrix can be represented by a Rodrigues vector. In this case, the vector is represented by a rotational axis, and a length of the vector is represented by a rotational amount. The rotation matrix may be represented by a quaternion that expresses a rotation with a rotational axis and a rotational amount similarly as the Rodrigues vector. The Rodrigues vector and the quaternion are one-to-one convertible, and a calculation method for the conversion is disclosed in Document D2 below.
Document D2: D. Mortari, F. Markley, and P. Singla. Optimal linear attitude estimator. Journal of Guidance, Control. and Dynamics (JGCD), 3:1619-1627, 2007.

Thus, one of the rotational representations described above, which are interconvertible for the three-dimensional rotation, can be used according to processing contents.

A point p in the world coordinate system and a pixel u in the image coordinate system are associated with each other using a camera model represented by the equations (1) and (2). The point p is a point on a unit sphere around the origin of the world coordinate system.

$$\begin{matrix}[ Formula 1 ] & \\ \begin{matrix}u = [ \begin{matrix}γ / {d}_{u} & 0 & {c}_{u} \\ 0 & γ / {d}_{υ} & {c}_{υ} \\ 0 & 0 & 1\end{matrix} ] [ R \vert t ] p .\end{matrix} & ( 1 )\end{matrix}$$

$$γ = f \cdot ( η + {k}_{1} {η}^{3} ) , \qquad ( 2 )$$

“u” denotes two-dimensional coordinate data representing an image coordinate system. “R” denotes a rotation matrix indicative of a rotation between the camera coordinate system 22 and the world coordinate system 21. “t” denotes a translation vector indicative of a translation between the camera coordinate system 22 and the world coordinate system 21. In the present disclosure, a movement amount by the translation vector in the camera parameter to be estimated from an image can be freely selected; therefore, the translation vector is assumed to be a zero vector. (cᵤₚ, cᵥ) denotes the image principal point. (dᵤ, dᵥ) denotes the pixel pitch of the image sensor of the camera 2, which is already known. “γ” denotes the distortion. The distortion γ is represented by the equation (2). In the equation (2), “n” denotes an incident angle, and “k₁” denotes a distortion coefficient. The rotation matrix R and the translation vector t are examples of the extrinsic parameter of the camera 2.

The projection part 114 projects the vanishing points estimated from the image onto the unit sphere using this camera model. The equation (1) represents forward projection to project a world coordinate to an image coordinate, and backprojection to determine a world coordinate from an image coordinate is given as a positive real root obtained by solving a cubic equation of the incident angle n. The backprojection is calculated, supposing that the rotation matrix R is a unit matrix and the translation vector t is the zero vector in the equation (1), in order to acquire a world coordinate corresponding to a sight vector of the camera. The backprojection causes dimensional increase from two dimensions for the image coordinate to three dimensions for the world coordinate; however, selecting a world coordinate on the unit sphere enables unique determination of a backprojection point. A vanishing point that matches the image principal point cannot be projected onto the unit sphere, i.e., is a singularity. Thus, in a case where a vanishing point matches the image principal point, the projection part 114 adds a minute quantity to a coordinate of the vanishing point. The minute quantity is, e.g., 0.0000001. The equation (1) indicates that projection from an image to the unit sphere corresponds to backprojection, which will be, however, simply referred to as projection in the description below.

Referring back to FIG. 5, the calculation part 115 calculates a rotation angle indicative of the posture of the camera 2 on the basis of errors between the vanishing points projected onto the unit sphere and a plurality of reference vanishing points projected onto the unit sphere in advance. The rotation angle represents a rotation of the camera 2 with respect to the world coordinate system 21. The rotation angle includes the pan angle, the tilt angle, and the roll angle. With reference to FIG. 3, the pan angle φ represents a rotation of the camera 2 around a pan axis (Yc-axis); the tilt angle represents a rotation of the camera 2 around a tilt axis (Xc-axis); and the roll angle represents a rotation of the camera 2 around a roll axis (Zc). The reference vanishing point refers to a vanishing point under no rotation of the camera coordinate system 22 with respect to the world coordinate system 21. The reference vanishing point will be described later in a third embodiment. The error between a vanishing point and a reference vanishing point refers to an angle between the projected vanishing point and the reference vanishing point with respect to the origin of the world coordinate system 21.

Specifically, the calculation part 115 specifies a rotation angle for the vanishing points to minimize errors between the projected vanishing points and the reference vanishing points, and determines the specified minimum rotation angle as the rotation angle indicative of the posture of the camera 2. The minimization of the errors is known as an absolute orientation problem, and Document D3 below discloses a solution to the problem, in which a quaternion to minimize the errors is calculated.
Document D3: Z. Wang and Jepson. A new closed-form solution for absolute orientation. In Proceedings of IEEE Conference on Computer Vision and Pattern Recognition (CVPR), pages 129-134, 1994.

Document D2 also provides a solution with a low calculation cost to the absolute orientation problem. In Document D2, a Rodrigues vector to minimize the errors is calculated. Hereinafter, a calculation method of the rotation angle based on the solution of Document D2 will be described, but the rotation angle may be calculated on the basis of the solution disclosed in Document D3. In this case, a quaternion is calculated directly.

The calculation part 115 calculates the errors between the vanishing points and the reference vanishing points corresponding to the respective vanishing points. The calculation part 115 calculates a Rodrigues vector to minimize the errors. The Rodrigues vector is defined on the basis of a rotational axis (principal axes) of a rotation to minimize the errors and a rotational amount to minimize the errors. The calculation part 115 calculates a quaternion from the Rodrigues vector. The calculation part 115 calculates the pan angle, the tilt angle, and the roll angle from the quaternion. Thus, the rotation angle of the camera 2 is calculated.

The output part 116 outputs the rotation angle of the camera 2 calculated by the calculation part 115. The output part 116 outputs the rotation angle to the memory 120, or may output the rotation angle to an external device or output the rotation angle to the camera 2. The pan angle, the tilt angle, and the roll angle are convertible with the Rodrigues vector or the quaternion described above. Therefore, the output part 116 may output the Rodrigues vector or the quaternion instead of the rotation angle. As described above, the output part 116 may output the rotation angle in a representation desirable for an application to use the rotation angle. This can eliminate unnecessary calculation.

The memory 120 stores, e.g., the world coordinate system 21 and the camera coordinate system 22 initially set in the first embodiment.

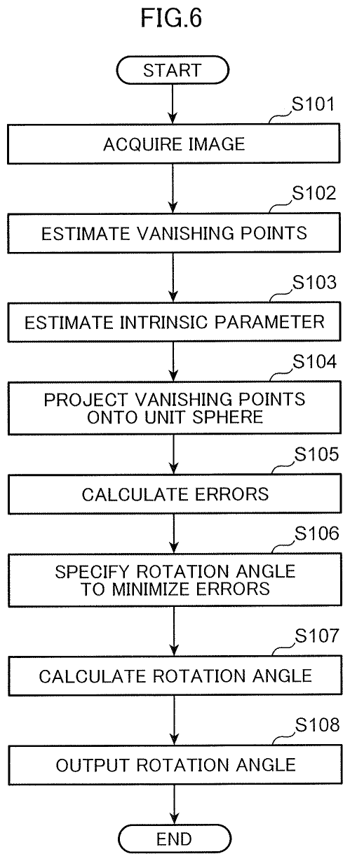

FIG. 6 is a flowchart showing an exemplary process of the information processing apparatus 1A according to the second embodiment. First, in Step S101, the acquisition part 11 acquires an image from the camera 2. Next, in Step S102, the vanishing point estimation part 112 estimates vanishing points by inputting the image to the first learning model. The first learning model outputs six respective heatmaps corresponding to the first to sixth vanishing points. The vanishing point estimation part 112 detects a peak on each of the six heatmaps output by the first learning model, and determines that a vanishing point has been estimated in a case where the detected peak is not less than a threshold. For example, in a case where a peak of the heatmap corresponding to the first vanishing point is not less than a threshold, it is determined that the first vanishing point has been estimated. For example, in a case where a peak of the heatmap corresponding to the second vanishing point is less than a threshold, it is determined that the second vanishing point has not been estimated. The vanishing point estimation part 112 detects the peak using a method with application of the Gaussian filter as described above, or may detect the peak with subpixel accuracy.

Next, in Step S103, the intrinsic parameter estimation part 113 estimates the intrinsic parameter by inputting the image to the second learning model. In this step, the focal length f and the distortion coefficient k₁ are estimated.

Next, in Step S104, the projection part 114 projects the vanishing points estimated in Step S102 onto a unit sphere by applying the intrinsic parameter estimated in Step S103 to the camera model.

Next, in Step S105, the calculation part 115 calculates errors between the vanishing points projected onto the unit sphere and reference vanishing points corresponding to the vanishing points, the reference vanishing points being projected onto the unit sphere in advance. For example, in a case where the first vanishing point and the third vanishing point are estimated, an error between the first vanishing point and a first reference vanishing point that is a reference vanishing point for the first vanishing point, and an error between the third vanishing point and a third reference vanishing point that is a reference vanishing point for the third vanishing point are calculated.

Next, in Step S106, the calculation part 115 specifies a rotation angle for the vanishing points to minimize the errors calculated in Step S105. This process is described above.

Next, in Step S107, the calculation part 115 determines the rotation angle to minimize the errors obtained in Step S106 as the rotation angle of the camera 2.

Next, in Step S108, the output part 116 outputs the calculated rotation angle of the camera 2. Thus, the pan angle, the tilt angle, and the roll angle of the camera 2 are obtained.

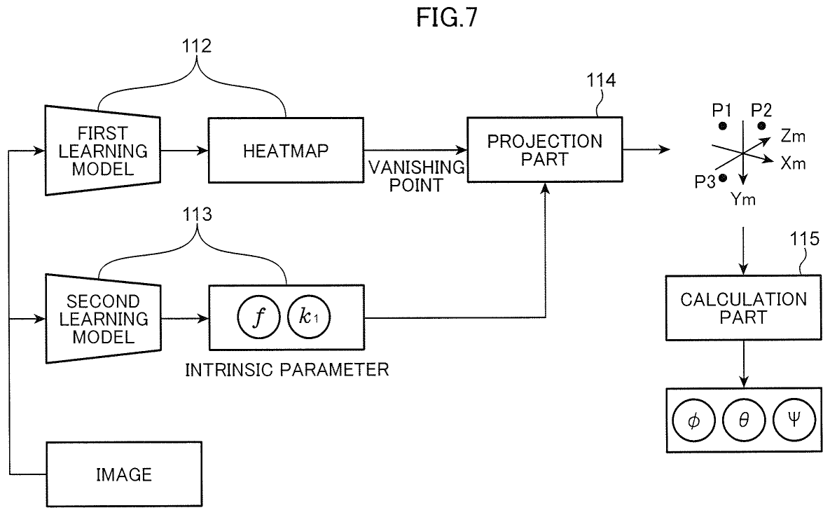

FIG. 7 is a diagram showing an outline of the process in the second embodiment. The image taken by the camera 2 is input to the first learning model and the second learning model. The first learning model outputs the heatmap. The second learning model outputs the intrinsic parameter. The vanishing point estimation part 112 estimates the vanishing point from the heatmap. The projection part 114 projects the vanishing point onto the unit sphere around the origin of the world coordinate system 21 using the intrinsic parameter. In this example, three vanishing points P1 to P3 are estimated, and thus the three vanishing points P1 to P3 are projected onto the unit sphere. The calculation part 115 calculates errors between the vanishing points P1 to P3 and reference vanishing points corresponding to the respective vanishing points PI to P3. The calculation part 115 calculates the pan angle φ, a pitch angle θ, and the roll angle ψ on the basis of the calculated errors.

As described above, in the second embodiment, a plurality of vanishing points is estimated by inputting an image to the first learning model, instead of estimation of a plurality of vanishing points from an arc; thus, a vanishing point can be accurately estimated even for a place where contours of a building are blurred. Further, the estimated vanishing points are projected onto the unit sphere on the basis of the intrinsic parameter estimated from the image, and the rotation angle indicative of the posture of the camera is estimated on the basis of the errors between the projected vanishing points and the reference vanishing points. Therefore, the posture of the camera can be accurately estimated.

### Modification of Second Embodiment

The camera 2 may be disposed on the mover 3 with an optical axis being in a direction intersecting the front direction. This configuration makes many vanishing points more likely to appear on an image and thus facilitates estimation of a plurality of vanishing points. For example, the camera 2 may be disposed on the mover 3 to face obliquely downward at a certain angle (e.g., 30 degrees, 45 degrees) with respect to the front direction.

### Third Embodiment

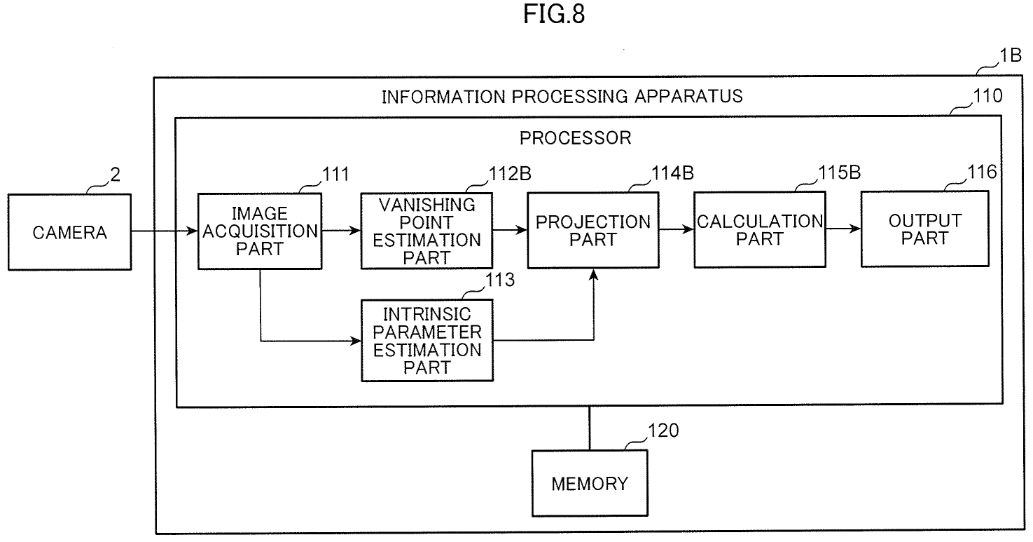

The third embodiment involves auxiliary diagonal points in addition to the vanishing point for the estimation of the rotation angle of the camera 2. FIG. 8 is a diagram showing an exemplary configuration of an information processing apparatus 1B according to the third embodiment. In the third embodiment, the same constituents as those in the first and second embodiments are denoted by the same reference numerals, and the description thereof will be omitted. The processor 110 of the information processing apparatus 1B has a particular different configuration, i.e., a vanishing point estimation part 112B (an exemplary estimation part), a projection part 114B, and a calculation part 115B.

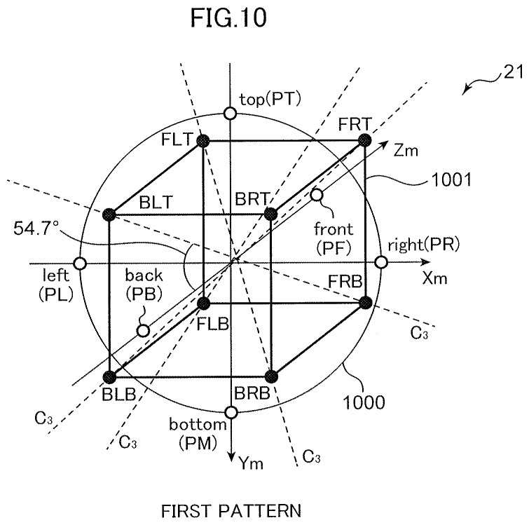

The vanishing point estimation part 112B further estimates auxiliary diagonal points in addition to the vanishing point. FIG. 10 is an illustration showing vanishing points and auxiliary diagonal points projected on a unit sphere 1000. The unit sphere 1000 is arranged to have a center at the origin of the world coordinate system 21.

There are six vanishing points PF, PB, PT, PM, PR, and PL. The six vanishing points projected onto the unit sphere 1000 with the camera model described above are at six vertices of a regular octahedron (unillustrated) inscribed in the unit sphere 1000. Each of the six vertices of the regular octahedron is on one of the Xm, Ym, and Zm axes. In other words, the vanishing points PT, PM are on the Ym axis, the vanishing points PF, PB are on the Zm axis, and the vanishing points PR, PL are on the Xm axis.

The vanishing point PF is a vanishing point in the front direction of the camera 2, which is the first vanishing point described above. The vanishing point PB is a vanishing point in a direction opposite to the front direction of the camera 2, which is the second vanishing point described above. The vanishing point PT is a vanishing point in the zenithal direction of the camera 2, which is the third vanishing point described above. The vanishing point PM is a vanishing point in a direction opposite to the zenithal direction of the camera 2, which is the fourth vanishing point described above. The vanishing point PR is a vanishing point in the rightward direction of the camera 2, which is the fifth vanishing point described above. The vanishing point PL is a vanishing point in the leftward direction of the camera 2, which is the sixth vanishing point described above.

As described above, the vanishing points represent positive infinity and negative infinity directions of each axis of a three-dimensional rectangular coordinate system. At least six vanishing points having three-dimensional coordinates form a regular octahedron on the unit sphere on the basis of a positional relationship of the vanishing points. The regular octahedron is a regular polygon and has high symmetry. From a characteristic of the regular octahedron (also referred to as regular octahedron groups) having high symmetry, auxiliary diagonal points, which will be described later, have been conceived.

There are eight auxiliary diagonal points FRT, FLT, BLT, BRT, FRB, FLB, BLB, and BRB. The auxiliary diagonal points are eight points arranged to maintain the symmetry of the regular octahedron inscribed in the unit sphere 1000. FIG. 10 shows an arrangement of eight auxiliary diagonal points that provides high spatial uniformity. The eight auxiliary diagonal points are at eight vertices of a cube 1001 inscribed in the unit sphere 1000 and having an upper face orthogonal to, e.g., the Ym axis. The eight auxiliary diagonal points are arranged spatially uniformly, and have the symmetry of regular octahedron group. The arrangement pattern of the eight auxiliary diagonal points shown in FIG. 10 is referred to as a first pattern.

The auxiliary diagonal point FRT is an auxiliary diagonal point in the forward direction, the rightward direction, and an upward direction. The auxiliary diagonal point FLT is an auxiliary diagonal point in the forward direction, the leftward direction, and the upward direction. The auxiliary diagonal point BLT is an auxiliary diagonal point in the rearward direction, the leftward direction, and the upward direction. The auxiliary diagonal point BRT is an auxiliary diagonal point in the rearward direction, the rightward direction, and the upward direction. The auxiliary diagonal point FRB is an auxiliary diagonal point in the forward direction, the rightward direction, and a downward direction. The auxiliary diagonal point FLB is an auxiliary diagonal point in the forward direction, the leftward direction, and the downward direction. The auxiliary diagonal point BLB is an auxiliary diagonal point in the rearward direction, the leftward direction, and the downward direction. The auxiliary diagonal point BRB is an auxiliary diagonal point in the rearward direction, the rightward direction, and the downward direction.

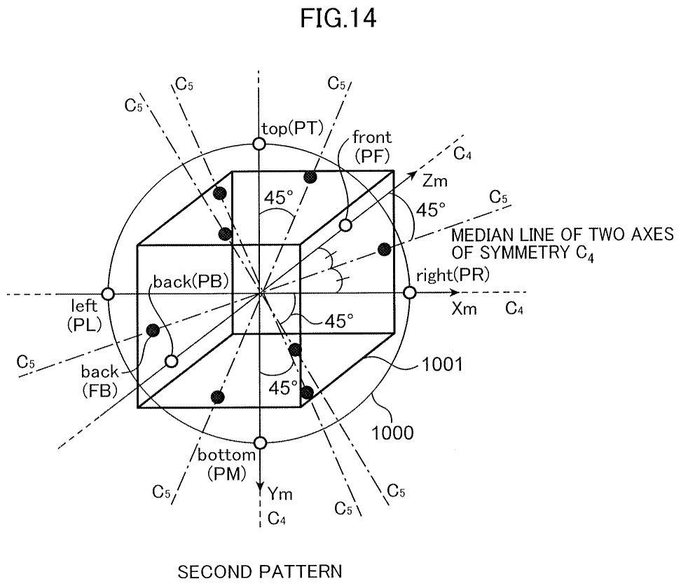

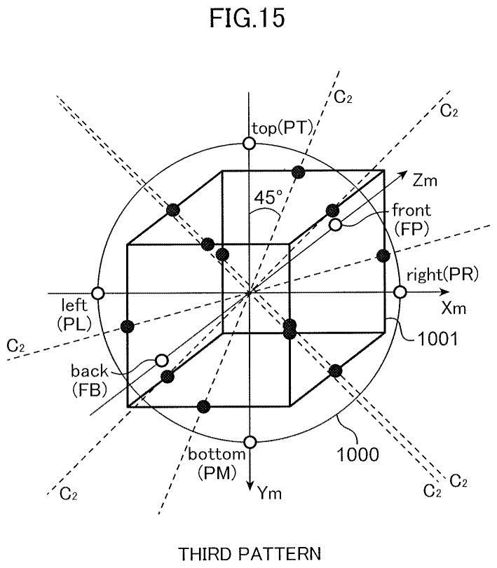

There are other arrangements of the auxiliary diagonal points to maintain the symmetry of the regular octahedron. FIG. 14 is an illustration showing an arrangement of auxiliary diagonal points as a second pattern. FIG. 15 is an illustration showing an arrangement of auxiliary diagonal points as a third pattern. The regular octahedron groups have six axes of symmetry C₂ (FIG. 15), four axes of symmetry C₃ (FIG. 10), and three axes of symmetry C₄ (FIG. 14), respectively. Cₙ denotes a Schoenflies notation and represents an axis of symmetry for 360°/n-rotational symmetry. It is necessary for maintaining the symmetry of the regular octahedron to arrange auxiliary diagonal points on the axes of symmetry C₂, the axes of symmetry C₃, or the axes of symmetry C₄, or arrange auxiliary diagonal points to be symmetry with respect to the axes. Using many auxiliary diagonal points provides a stronger constraint for the estimation of the extrinsic parameter of the camera; however, in a case where many auxiliary diagonal points are estimated, it becomes difficult to perform optimization in training of a deep neural network. Therefore, practically, an arrangement that involves fewer auxiliary diagonal points and provides high spatial uniformity is desirable; the auxiliary diagonal points in the first pattern are desirable for the estimation of the camera parameter. In the first pattern, the auxiliary diagonal points are arranged on the axes of symmetry C₃. In the third pattern, the auxiliary diagonal points are arranged on the axes of symmetry C₂. In the third pattern, 12 points are arranged in total, which are four midpoints of respective four sides of an upper face of the cube 1001, four midpoints of respective four sides of a lower face of the cube 1001, and four midpoints of respective four sides of the cube 1001 that are parallel to the Ym axis. The upper face of the cube 1001 refers to a face close to the vanishing point PT, and the lower face of the cube 1001 refers to a face close to the vanishing point PM.

In the second pattern, eight auxiliary diagonal points are arranged on median lines C₅ for three axes of symmetry C₄. In other words, the second pattern involves eight auxiliary diagonal points corresponding to intersections between the four median lines C₅ and the unit sphere 1000.

Among the arrangement patterns of the eight points to maintain the symmetry of the regular octahedron, the arrangement pattern that maximizes a minimum of angles formed by two points of the eight auxiliary diagonal points and the origin provides the highest spatial uniformity. Such a minimum of the angles is 54.7 degrees in the first pattern. The first pattern indicates 54.7 degrees and the second pattern indicates 45 degrees; thus, the first pattern is larger than the second pattern. In a case where there are eight auxiliary diagonal points, a result of a study covering the third pattern in which the auxiliary diagonal points are arranged on the axes of symmetry C₂ was that the minimum of the angles in the first pattern was the highest. Thus, the example in FIG. 10 involves the auxiliary diagonal points in the first pattern, but this is merely an example; the second pattern or the third pattern may be used. Alternatively, 16 auxiliary diagonal points from the first pattern and the second pattern may be used, or those from the first pattern, the second pattern, and the third pattern may be used. In other words, a pattern including at least one of the first to third patterns can be used.

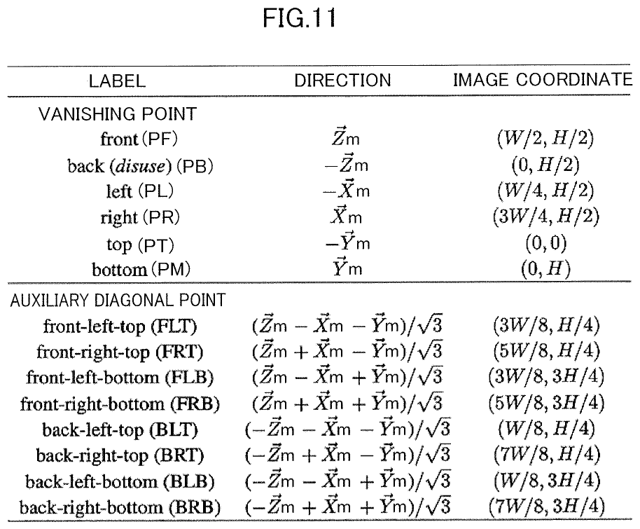

FIG. 11 is a table showing arrangement of the vanishing points and the auxiliary diagonal points shown in FIG. 10. “LABEL” represents a label indicative of a type of a vanishing point or a type of an auxiliary diagonal point. “DIRECTION” represents a vector indicative of a direction from the origin toward a vanishing point or an auxiliary diagonal point. “IMAGE COORDINATE” represents a coordinate of a vanishing point or an auxiliary diagonal point in a panoramic image as a projection source. The panoramic image is represented by equirectangular projection. “W” denotes a width of the panoramic image, and “H” denotes a height of the panoramic image. The vectors “Xm”, “Ym”, and “Zm” shown in the column for “DIRECTION” represent unit vectors along the Xm, Ym, and Zm axes, respectively.

For example, the vanishing point PF is at (W/2, H/2) in the panoramic image, and in a direction represented by the vector Zm in the world coordinate system 21. The vanishing point PB is at (0, H/2) in the panoramic image, and in a direction represented by the vector −Zm in the world coordinate system 21. The vanishing point PL is at (W/4, H/2) in the panoramic image, and in a direction represented by the vector −Xm in the world coordinate system 21. The vanishing point PR is at (3W/4, H/2) in the panoramic image, and in a direction represented by the vector Xm in the world coordinate system 21. The vanishing point PT is at (0, 0) in the panoramic image, and in a direction represented by the vector −Ym in the world coordinate system 21. The vanishing point PM is at (0, H) in the panoramic image, and in a direction represented by the vector Ym in the world coordinate system 21.

For example, the auxiliary diagonal point FLT is at (3W/8, H/4) in the panoramic image, and in a direction represented by (Vector Zm-Vector Xm-Vector Ym)/√3 in the world coordinate system 21. The auxiliary diagonal point FRT is at (5W/8, H/4) in the panoramic image, and in a direction represented by (Vector Zm+Vector Xm—Vector Ym)/√3 in the world coordinate system 21. The auxiliary diagonal point FLB is at (3W/8, 3H/4) in the panoramic image, and in a direction represented by (Vector Zm−Vector Xm+Vector Ym)/√3 in the world coordinate system 21. The auxiliary diagonal point FRB is at (5W/8, 3H/4) in the panoramic image, and in a direction represented by (Vector Zm+Vector Xm+Vector Ym)/√3 in the world coordinate system 21. The auxiliary diagonal point BLT is at (W/8, H/4) in the panoramic image, and in a direction represented by (−Vector Zm−Vector Xm−Vector Ym)/V3 in the world coordinate system 21. The auxiliary diagonal point BRT is at (7W/8, H/4) in the panoramic image, and in a direction represented by (−Vector Zm+Vector Xm−Vector Ym)/√3 in the world coordinate system 21. The auxiliary diagonal point BLB is at (W/8, 3H/4) in the panoramic image, and in a direction represented by (−Vector Zm−Vector Xm+Vector Ym)/√3 in the world coordinate system 21. The auxiliary diagonal point BRB is at (7W/8, 3H/4) in the panoramic image, and in a direction represented by (−Vector Zm+Vector Xm+Vector Ym)/√3 in the world coordinate system 21.

As described above, each of the six vanishing points and the eight auxiliary diagonal points shown in FIG. 10 is arranged in the direction shown in FIG. 11 in the world coordinate system 21.

The vanishing points and the auxiliary diagonal points shown in FIG. 10 and FIG. 11 represent reference vanishing points and reference auxiliary diagonal points. The reference vanishing point is an ideal vanishing point projected onto the unit sphere 1000 under no rotation of the camera coordinate system 22 with respect to the world coordinate system 21. The reference auxiliary diagonal point is an ideal auxiliary diagonal point projected onto the unit sphere 1000 under no rotation of the camera coordinate system 22 with respect to the world coordinate system 21. Therefore, in a case where the camera coordinate system 22 is rotated with respect to the world coordinate system, six vanishing points and eight auxiliary diagonal points are projected at positions deviated from the six reference vanishing points and the eight reference auxiliary diagonal points, respectively.

Referring back to FIG. 8, the vanishing point estimation part 112B estimates a vanishing point and an auxiliary diagonal point by inputting the image to a first learning model. The first learning model is trained by machine learning in advance for estimating the vanishing point and the auxiliary diagonal points. The first learning model outputs a heatmap representing a likelihood of vanishing point at each of a plurality of pixels from the input image. The first learning model further outputs a heatmap indicative of a likelihood of auxiliary diagonal point at each of a plurality of pixels from the input image. The first learning model is generated by machine learning using heatmaps indicative of true values for the vanishing point and the auxiliary diagonal point as training data. The vanishing point estimation part 112B estimates the vanishing point on the basis of the heatmap for the vanishing point output by the first learning model, and estimates an auxiliary diagonal point on the basis of the heatmap for the auxiliary diagonal point output by the first learning model.

The projection part 114B projects the vanishing point and the auxiliary diagonal point estimated by the vanishing point estimation part 112B to the unit sphere 1000 in the world coordinate system 21 by using the camera model represented by the equations (1) and (2).

The calculation part 115B calculates the rotation angle indicative of the posture of the camera 2 on the basis of the error between the vanishing point projected by the projection part 114B and the reference vanishing point projected onto the unit sphere 1000 in advance, and the error between the auxiliary diagonal point projected by the projection part 114B and the reference auxiliary diagonal point projected onto the unit sphere 1000 in advance. The error between the auxiliary diagonal point and the reference auxiliary diagonal point is an angle formed by the auxiliary diagonal point and the reference auxiliary diagonal point with respect to the origin in the world coordinate system 21.

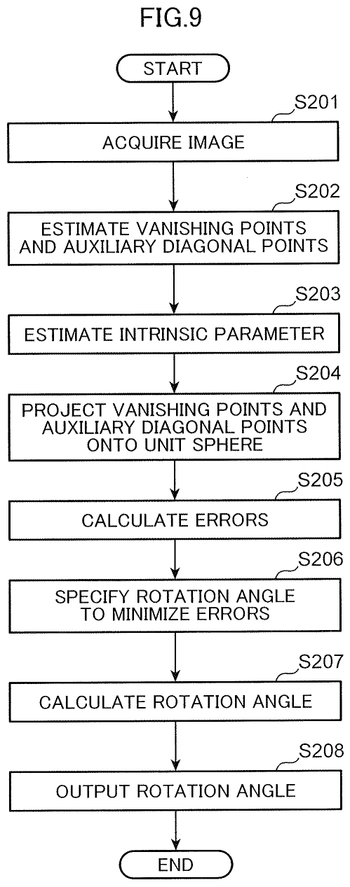

FIG. 9 is a flowchart showing an exemplary process of the information processing apparatus 1B according to the third embodiment. The procedure in Step S201 is the same as that in S101 in FIG. 6. Next, in Step S202, the vanishing point estimation part 112B estimates the vanishing points and the auxiliary diagonal points by inputting the image to the first learning model. The first learning model outputs six heatmaps corresponding to the six vanishing points shown in FIG. 10, and outputs eight heatmaps corresponding to the eight auxiliary diagonal points shown in FIG. 10. The vanishing point estimation part 112B detects a peak from each of the six heatmaps corresponding to the vanishing points output by the first learning model, and determines that a vanishing point is estimated if the detected peak is not lower than a threshold. The vanishing point estimation part 112B further determines that an auxiliary diagonal point is estimated if a peak of each of the eight heatmaps corresponding to the auxiliary diagonal points output by the first learning model is not lower than a threshold. For example, it is determined that the auxiliary diagonal point FRT is estimated if the peak of the heatmap corresponding to the auxiliary diagonal point FRT is not lower than a threshold; and it is determined that the auxiliary diagonal point BLB is not estimated if the peak of the heatmap corresponding to the auxiliary diagonal point BLB is lower than a threshold.

The procedure in Step S203 is the same as that in Step S103 in FIG. 6. Next, in Step S204, the projection part 114B projects the vanishing point and the auxiliary diagonal point estimated in Step S202 onto the unit sphere 1000 by applying the intrinsic parameter estimated in Step S203 to the camera model.

Next, in Step S205, the calculation part 115B calculates an error between the vanishing point projected onto the unit sphere 1000 and a reference vanishing point that corresponds to the vanishing point and is projected onto the unit sphere in advance, and calculates an error between the auxiliary diagonal point projected onto the unit sphere 1000 and a reference auxiliary diagonal point that corresponds to the auxiliary diagonal point and is projected onto the unit sphere 1000 in advance. For example, in a case where the vanishing point PF and the auxiliary diagonal point FRT are estimated, an error between the vanishing point PF and a reference vanishing point for the vanishing point PF and an error between the auxiliary diagonal point FRT and a reference auxiliary diagonal point for the auxiliary diagonal point FRT are calculated.

Next, in Step S206, the calculation part 115B specifies a rotation angle for the vanishing point and the auxiliary diagonal point to minimize the errors calculated in Step S205. This procedure is the same as that in the first embodiment except that the procedure additionally involves an auxiliary diagonal point as well as the vanishing point; thus, the detailed description thereof will be omitted. The procedures in Steps S207 and S208 are the same as those in Steps S107 and S108.

As described above, in the third embodiment, the auxiliary diagonal points are estimated in addition to the vanishing point. The auxiliary diagonal points include eight or more points that can maintain the symmetry of the six vanishing points corresponding to the vertices of the regular octahedron projected onto the unit sphere 1000. Thus, the projected auxiliary diagonal points are arranged spatially uniformly and have the strong geometric constraint similar to the vanishing point. This configuration can provide information that enables unique determination of the posture of the camera regardless of lack of a vanishing point estimated from an image.

### Fourth Embodiment

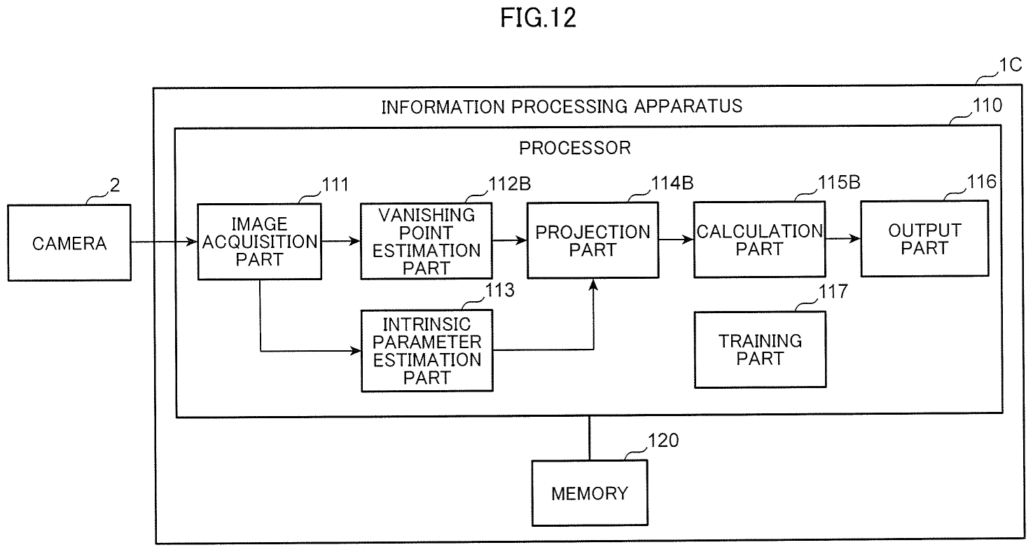

The fourth embodiment involves generation of a trained model by use of a learning model for pose estimation. FIG. 12 is a diagram showing an exemplary configuration of an information processing apparatus 1C according to the fourth embodiment. In the fourth embodiment, the same constituents as those in the first to third embodiments are denoted by the same reference numerals, and the description thereof will be omitted. The processor 110 of the information processing apparatus 1C further includes a training part 117, in addition to the configuration of the third embodiment. The trained model corresponds to the first learning model shown in the second and third embodiments. A learning model before training or in training is referred to as an untrained model.

The training part 117 trains an untrained model by machine learning with training data to generate a trained model. The training data includes a training image and true value heatmaps indicative of true values for a vanishing point and an auxiliary diagonal point included in the training image. The true value heatmaps include six true value heatmaps corresponding to the six vanishing points shown in FIG. 10 and eight true value heatmaps corresponding to the eight auxiliary diagonal points shown in FIG. 10.

The training part 117 trains the untrained model by machine learning, using a loss function for evaluating an error between an estimation heatmap and a true value heatmap that are output by inputting the training image to the untrained model. The learning model outputs six heatmaps corresponding to the six vanishing points shown in FIG. 10. The learning model outputs eight heatmaps corresponding to the eight auxiliary diagonal points shown in FIG. 10.

The loss function uses a vanishing point included in the estimation heatmap and a vanishing point not included in the estimation heatmap to evaluate the error. Further, the loss function uses two auxiliary diagonal points of an auxiliary diagonal point included in the estimation heatmap and an auxiliary diagonal point not included in the estimation heatmap to evaluate the error.

The HRNet disclosed in Document D4, which is widely used for pose estimation, can be used as the untrained model. In machine learning for the HRNet for pose estimation, the untrained model outputs a specific number of estimation heatmaps, the specific number being the same as the number of anatomical keypoints to be estimated; an estimation heatmap is determined to include an anatomical keypoint if having a peak not lower than a threshold. For example, each of the pixels on the estimation heatmap takes a value from 0 to 1, and the threshold is, e.g., 0.8. The loss function of the HRNet for pose estimation calculates a squared error for each pixel of a true value heatmap and an estimation heatmap, and calculates a sum of the errors as an evaluation value for the errors. In the machine learning for the HRNet for pose estimation, a squared error is calculated only for an estimation heatmap including an anatomical keypoint, and a squared error is not calculated for an estimation heatmap not including an anatomical keypoint. The loss function in the HRNet for pose estimation is represented by the equation (3).
Document D4: K. Sun, B. Xiao, D. Liu, and J. Wang. Deep high-resolution representation learning for human pose estimation. In Proceedings of IEEE/CVF Conference on Computer Vision and Pattern Recognition (CVPR), pages 5686-5696, 2019.

$$\begin{matrix}[ Formula 2 ] & \\ {J}_{pose} = {\sum }_{i = 1}^{N} {a}_{i} ( {\sum }_{j = 1}^{M} {( {s}_{j} - {s}_{j}^{′} )}^{2} ) & ( 3 )\end{matrix}$$

$${J}_{VP} = {\sum }_{i = 1}^{N} ( {\sum }_{j = 1}^{M} {( {s}_{j} - {s}_{j}^{′} )}^{2} ) \qquad ( 4 )$$

“Jₚₒₛₑ” denotes the evaluation value by the loss function. “N” denotes the number of anatomical keypoints determined to be included in the estimation heatmaps, and “i” denotes an index for the anatomical keypoints. “M” denotes the number of pixels of an estimation heatmap, and “j” denotes an index for the pixels. “sⱼ” denotes a pixel value of the estimation heatmap, and “sⱼ′” denotes a pixel value of a true value heatmap. “aᵢ” denotes a Boolean value indicative of whether an anatomical keypoint is included in the estimation heatmap, which indicates “1” if included and indicates “0” if not included.

The Boolean value aᵢ is used in the equation (3) for the human pose estimation, which involves cases where a person is reflected or not reflected in an image, in order to preferentially use the case with the reflection for the training.

However, the loss function above is inappropriate for an estimation of a vanishing point in an image with the HRNet because it is necessary to take the vanishing points and the auxiliary diagonal points into consideration for each image, for all images are taken by respective cameras. In this regard, there is not always a vanishing point or an auxiliary diagonal point within an image, for there may be a vanishing point or an auxiliary diagonal point outside an image. Accordingly, in this embodiment, the untrained model is trained by machine learning, using a loss function without the Boolean value aᵢ. The loss function for the fourth embodiment is represented by the equation (4).

“Jᵥₚ” denotes an evaluation value. “N” denotes the number of vanishing points and the number of auxiliary diagonal points determined to exist for the estimation heatmaps, and “i” denotes an index for the vanishing points and the auxiliary diagonal points. “M”, “j”, “sⱼ”, and “sⱼ′” denote the same as in the equation (3). As shown in the equation (4), the Boolean value aᵢ is omitted in the embodiment. Thus, whether a vanishing point and an auxiliary diagonal point are included in the estimation heatmap or not, the vanishing point and the auxiliary diagonal point are used for evaluating the errors; therefore, a trained model to estimate a vanishing point and auxiliary diagonal points with high accuracy can be obtained.

The training part 117 modifies a parameter of the untrained model to minimize the errors indicated by the equation (4), and generates a trained model.

Training data is generated as follows. First, the training part 117 acquires a panoramic image taken by a calibrated camera. The panoramic image taken by the calibrated camera is convertible into any image, e.g., a fisheye image or an image without distortion. The training part 117 then determines a camera model. The camera model includes, e.g., a fisheye camera model representing equidistance projection. The training part 117 then determines camera parameters relevant to the pan angle, the tilt angle, the roll angle, the focal length, and the lens distortion using random numbers. The training part 117 then generates, from the panoramic image, a training image to be taken by a camera model having the camera parameters serving as true values. A typical image processing, e.g., OpenCV remap, is used for the generation. The training part 117 then obtains a label for a vanishing point or an auxiliary diagonal point as shown in FIG. 11 from an image coordinate of the panoramic image. The training part 117 then generates a binary image with pixel values of 1 for a vanishing point in the training image and 0 for the others. The training part 117 then generates a true value heatmap image by applying a two-dimensional Gaussian filter to the binary image. A standard deviation of the Gaussian filter is, e.g., two pixels. The peak after the application of the filter indicates less than 1. Therefore, the training part 117 multiplies pixel values of all the pixels of the true value heatmap by a constant such that the peak indicates 1. The training data is thus generated. The generated training data is stored in the memory 120.

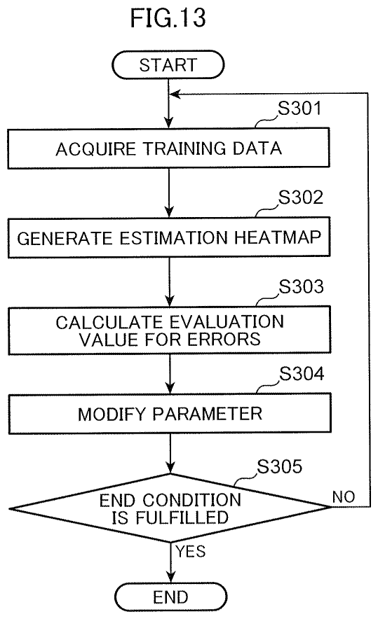

FIG. 13 is a flowchart showing an exemplary process of the information processing apparatus 1C according to the fourth embodiment. First, in Step S301, the training part 117 acquires the training data from the memory 120. Next, in Step S302, the training part 117 generates an estimation heatmap by inputting a training image in the training data to the untrained model. For example, six estimation heatmaps corresponding to the six vanishing points shown in FIG. 10 and eight estimation heatmaps corresponding to the eight auxiliary diagonal points, i.e., 14 heatmaps in total are generated; however, the training may not involve all of the six vanishing points and the eight auxiliary diagonal points. For example, the training may involve at least one vanishing point and at least one auxiliary diagonal point.

Next, in Step S303, the training part 117 calculates an evaluation value for errors between the estimation heatmap and the true value heatmap by using the equation (4).

Next, in Step S304, a parameter of the untrained model is modified to reduce the evaluation value. The modification is implemented by, e.g., backpropagation.

Next, the training part 117 determines whether an end condition for the machine learning is fulfilled. In a case where the end condition is fulfilled (YES in Step S305), the process ends. Thus, the trained model is generated. The generated trained model is stored in the memory 120. On the other hand, in a case where the end condition is not fulfilled (NO in Step S305), the process returns to Step S301, and Step S301 and subsequent steps are repeated. The end condition is, e.g., that the training has been performed a predetermined number of times.

As described above, in the fourth embodiment, a trained model is generated by subjecting an untrained model for pose estimation to machine learning using heatmaps indicative of true values for the vanishing point and the auxiliary diagonal points as training data, and the trained model is used to estimate the vanishing point. Thus, a learning model for pose estimation is used to obtain a trained model that can accurately estimate a vanishing point and auxiliary diagonal points. Consequently, a vanishing point and auxiliary diagonal points can be accurately estimated.

### Modification 1 of Fourth Embodiment

The trained model is constituted by the HRNet, but the present disclosure is not limited to this; any learning model capable of estimating a keypoint such as anatomical keypoint may constitute the trained model.

### Modification 2 of Fourth Embodiment

A trained model that estimates vanishing points only may be created by machine learning.

### Factors of Effects of Present Disclosure

The present disclosure provides higher accuracy, greater robustness, and a lower calculation cost than the conventional camera calibration methods, which will be described.

Non-Patent Literature 1 and Non-Patent Literature 2 disclose geometric methods for estimating pan, tilt, and roll angles.

In the conventional camera calibration methods, a vanishing point from a geometry-based arc detector is the only information available for the camera calibration. On the other hand, in the present disclosure, the auxiliary diagonal points, which cannot be extracted by the conventional geometry-based arc detector, can be utilized by using a deep neural network. An auxiliary diagonal point is not detectable by a geometry-based method unlike a vanishing point, but is detectable by using a deep neural network, for the auxiliary diagonal point conveys a geometric meaning of a diagonal direction. Thus, the proposed method involving many vanishing points and auxiliary diagonal points enables a camera calibration with higher accuracy than the conventional methods.

The conventional camera calibration methods require a combinatorial optimization with random numbers and iteration to estimate a vanishing point from many arcs, resulting in a high calculation cost. On the other hand, the present disclosure enables estimation of the pan angle, the tilt angle, and the roll angle without iterative calculation, resulting in a lower calculation cost than those by the conventional camera calibration methods.

Additionally, heatmap-based detection of a vanishing point and an auxiliary diagonal point is more robust than a conventional learning-based method involving no heatmap disclosed in Document D5 below.
Document D5: M. Lopez-Antequera, R. Mari, P. Gargallo, Y. Kuang, J. Gonzalez-Jimenez, and G. Haro. Deep single image camera calibration with radial distortion. In Proceedings of IEEE/CVF Conference on Computer Vision and Pattern Recognition (CVPR), pages 11809-11817, 2019.

A conventional estimation of the rotation angle by regression without using a heatmap involves learning based on the sky and a road that occupy a large region of an image; it is difficult to discriminate between the cloudy sky and the gray road; the areas of the sky and the road in the image are large, but it is difficult to extract a geometric feature. On the other hand, the heatmap-based method of the present disclosure of estimating the vanishing point and the auxiliary diagonal points, which are geometric feature points and have a strong constraint for the camera calibration, can achieve great robustness.

The present disclosure can be utilized in a technical field that involves estimation of a posture of a mover.

1. An information processing apparatus comprising:
an acquisition part for acquiring an image taken by a camera; and
an estimation part for estimating a vanishing point and auxiliary diagonal points from the image, wherein
the auxiliary diagonal points projected on a unit sphere in a world coordinate system include one point of a set of eight or more points arranged to maintain symmetry of a regular octahedron inscribed in the unit sphere.

2. The information processing apparatus according to claim 1, wherein the auxiliary diagonal points include at least one of eight vertices of a cube inscribed in the unit sphere.

3. The information processing apparatus according to claim 1, wherein
the estimation part includes
a vanishing point estimation part for estimating the vanishing point and the auxiliary diagonal points by inputting the image to a first learning model, and
an intrinsic parameter estimation part for estimating an intrinsic parameter of the camera by inputting the image to a second learning model,
the first learning model is trained by machine learning in advance for estimating the vanishing point and the auxiliary diagonal points, and
the second learning model is trained by machine learning in advance for estimating the intrinsic parameter.

4. The information processing apparatus according to claim 3, wherein
the first learning model generates heatmaps indicative of a likelihood of vanishing point and a likelihood of auxiliary diagonal point at each of a plurality of pixels from the input image, and
the vanishing point estimation part estimates the vanishing point and the auxiliary diagonal points on the basis of the heatmaps.

5. The information processing apparatus according to claim 1, further comprising:
a projection part for projecting the estimated vanishing point and auxiliary diagonal points onto the unit sphere on the basis of an intrinsic parameter of the camera; and
a calculation part for calculating a rotation angle indicative of a posture of the camera on the basis of errors between the vanishing point and the auxiliary diagonal points projected by the projection part, and a reference vanishing point and reference auxiliary diagonal points projected onto the unit sphere in advance.

6. An information processing method, by a computer, comprising:
acquiring an image taken by a camera; and
estimating a vanishing point and auxiliary diagonal points from the image, wherein
the auxiliary diagonal points projected on a unit sphere in a world coordinate system include one point of a set of eight or more points arranged to maintain symmetry of a regular octahedron inscribed in the unit sphere.

7. A non-transitory computer readable recording medium storing an information processing program causing a computer to serve as the information processing apparatus, the information processing program comprising:
acquiring an image taken by a camera; and
estimating a vanishing point and auxiliary diagonal points from the image, wherein the auxiliary diagonal points projected on a unit sphere in a world coordinate system include one point of a set of eight or more points arranged to maintain symmetry of a regular octahedron inscribed in the unit sphere.
